(19) United States
(12) Patent Application Publication
(10) Pub. No.: US 2026/0251496 A1
(43) Pub. Date: Aug. 27, 2026

(54) INTEGRATED SENSOR PACKAGE STRUCTURE

(71) Applicant: TONG HSING ELECTRONIC INDUSTRIES, LTD., Taoyuan City (TW)

(72) Inventors: YU-WEN LI, Taoyuan City (TW); CHIEN-CHEN LEE, Taoyuan City (TW); CHIEN-HENG LIN, Taoyuan City (TW)

(21) Appl. No.: 19/245,383

(22) Filed: Jun. 22, 2025

(30) Foreign Application Priority Data
Feb. 27, 2025 (TW) 114107219

(51) Int. Cl. G01J 1/04; G01J 1/02

(52) U.S. Cl. CPC G01J 1/0411; G01J 1/0204

(57) ABSTRACT

An integrated sensor package structure includes a substrate, a plurality of sensor modules disposed on the substrate, and a plurality of optical modules disposed on the substrate. Each of the sensor modules includes a sensor chip, a frame body surrounding the sensor chip, and a light-permeable member disposed on the frame body. The light-permeable member, the frame body, and the substrate jointly define an enclosed space, and the sensor chip is disposed in the enclosed space. Each of the optical modules includes a frame surrounding a corresponding one of the sensor modules and at least one lens mounted on the frame. A thickness of the sensor chip of at least one of the sensor modules is different from a thickness of the sensor chip of another one of the sensor modules.

### CROSS-REFERENCE TO RELATED PATENT APPLICATION

This application claims the benefit of priority to Taiwan Patent Application No. 114107219, filed on Feb. 27, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a sensor package structure, and more particularly to an integrated sensor package structure.

### BACKGROUND OF THE DISCLOSURE

Generally, in a conventional sensor package structure, a plurality of different sensor modules are individually packaged, and then the different sensor modules that are packaged are combined together. However, such a process may cause the conventional sensor package structure to have the problem of insufficient structural simplicity.

### SUMMARY OF THE DISCLOSURE

In response to the above-referenced technical inadequacy, the present disclosure provides an integrated sensor package structure, so as to mainly improve on the problem of insufficient structural simplicity in a conventional sensor package structure.

In order to solve the above-mentioned problem, one of the technical aspects adopted by the present disclosure is to provide an integrated sensor package structure. The integrated sensor package structure includes a substrate, a plurality of sensor modules, and a plurality of optical modules. Each of the sensor modules includes a sensor chip, a frame body, and a light-permeable member. The sensor chip is disposed on the substrate. The frame body is disposed on the substrate. The frame body surrounds the sensor chip. The light-permeable member is disposed on the frame body. The light-permeable member, the frame body, and the substrate jointly define an enclosed space, and the sensor chip is disposed in the enclosed space. Each of the optical modules includes a frame and at least one lens. The frame surrounds a corresponding one of the sensor modules. The at least one lens is mounted on the frame. A thickness of the sensor chip of at least one of the sensor modules is different from a thickness of the sensor chip of another one of the sensor modules.

In order to solve the above-mentioned problem, another one of the technical aspects adopted by the present disclosure is to provide an integrated sensor package structure. The integrated sensor package structure includes a substrate, a plurality of sensor modules, and an optical module. Each of the sensor modules includes a sensor chip, a frame body, and a light-permeable member. The sensor chip is disposed on the substrate. The frame body is disposed on the substrate. The frame body surrounds the sensor chip. The light-permeable member is disposed on the frame body. The light-permeable member, the frame body, and the substrate jointly define an enclosed space, and the sensor chip is disposed in the enclosed space. The optical module includes a frame and at least one lens. The frame is disposed on the substrate. The frame surrounds an outer periphery of each of the sensor modules, and the frame is integrally formed. The at least one lens is mounted on the frame. A thickness of the sensor chip of at least one of the sensor modules is different from a thickness of the sensor chip of another one of the sensor modules.

In order to solve the above-mentioned problem, yet another one of the technical aspects adopted by the present disclosure is to provide an integrated sensor package structure. The integrated sensor package structure includes a substrate, a plurality of sensor chips, a light-permeable member, and an optical module. The sensor chips are disposed on the substrate. The light-permeable member is arranged above the sensor chips. The optical module includes a frame and a plurality of lenses. The frame includes a supporting portion and a plurality of holding portions. The supporting portion is disposed on the substrate. The supporting portion surrounds the sensor chips and the light-permeable member. Each of the holding portions is disposed at one side of the supporting portion away from the substrate. The lenses are mounted on the holding portions of the frame. A thickness of at least one of the sensor chips is different from a thickness of another one of the sensor chips.

Therefore, in the integrated sensor package structure provided by the present disclosure, by virtue of “the sensor chips being disposed on the substrate” and “a thickness of at least one of the sensor chips being different from a thickness of another one of the sensor chips,” the problem of insufficient structural simplicity in the conventional sensor package structure can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an integrated sensor package structure according to a first embodiment of the present disclosure;

FIG. 2 is a schematic exploded view of the integrated sensor package structure according to the first embodiment of the present disclosure;

FIG. 3 is a schematic cross-sectional view taken along line III-III of FIG. 1;

FIG. 4 is a schematic enlarged view of part IV of FIG. 3;

FIG. 5 is a schematic perspective view of an integrated sensor package structure according to a second embodiment of the present disclosure;

FIG. 6 is a schematic exploded view of the integrated sensor package structure according to the second embodiment of the present disclosure;

FIG. 7 is a schematic cross-sectional view taken along line VII-VII of FIG. 5; and

FIG. 8 is a schematic view of an integrated sensor package structure according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

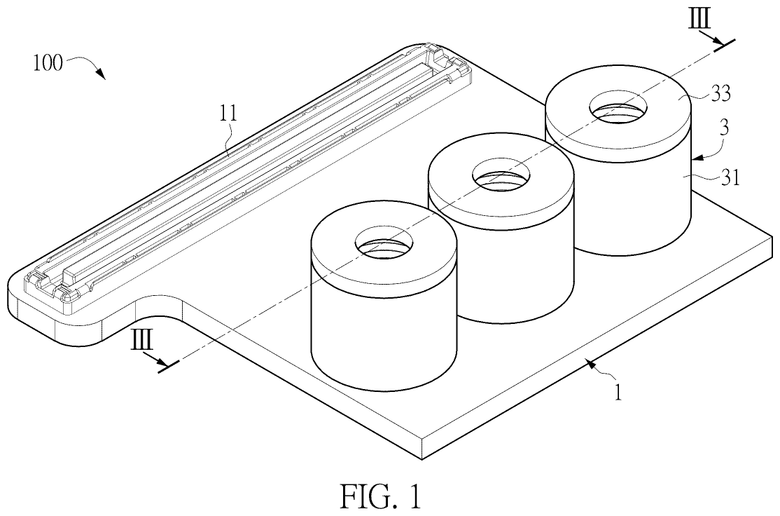

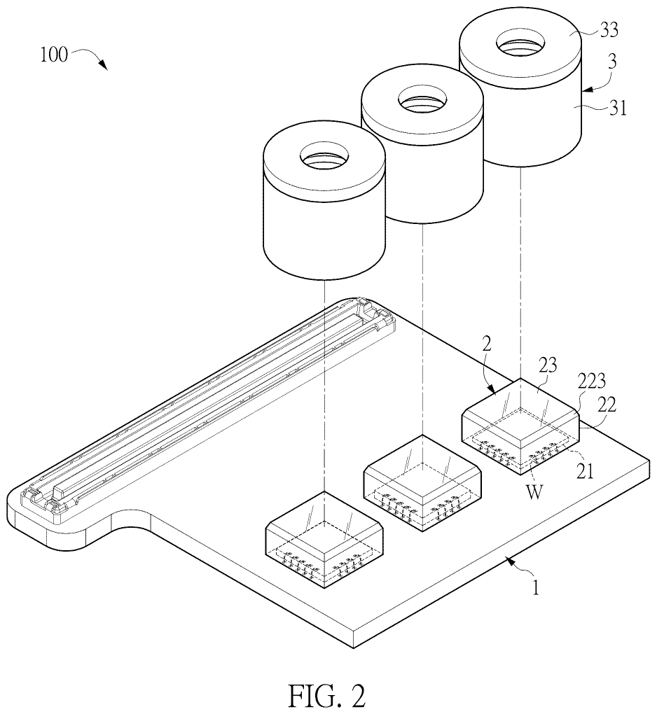

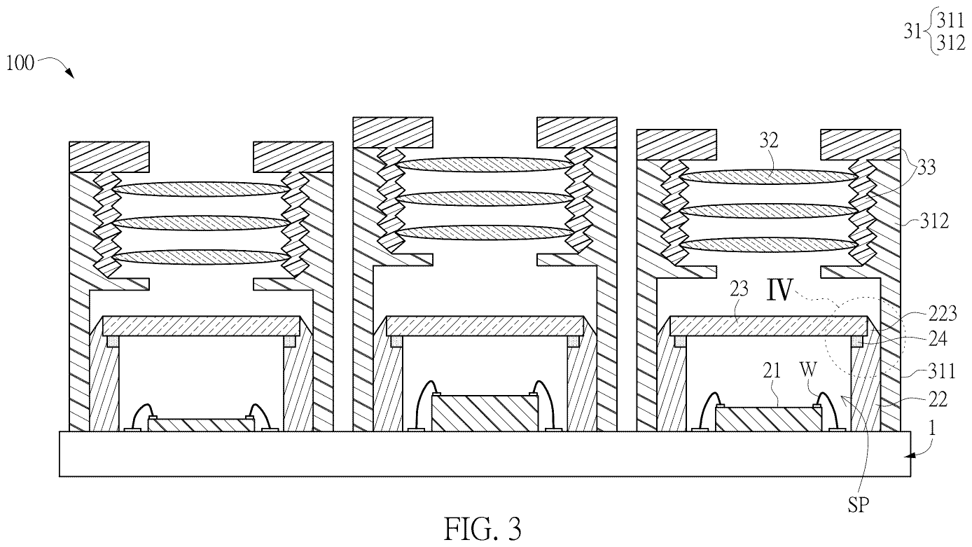

Referring to FIG. 1 to FIG. 3, FIG. 1 is a schematic perspective view of an integrated sensor package structure according to a first embodiment of the present disclosure, FIG. 2 is a schematic exploded view of the integrated sensor package structure according to the first embodiment of the present disclosure, and FIG. 3 is a schematic cross-sectional view taken along line III-III of FIG. 1. A first embodiment of the present disclosure provides an integrated sensor package structure 100. The integrated sensor package structure 100 includes a substrate 1, a plurality of sensor modules 2 disposed on the substrate 1, and a plurality of optical modules 3 disposed on the substrate 1. Each of the sensor modules 2 can correspond in position to one of the optical modules 3.

In the present embodiment, the substrate 1 can be, for example, a ceramic substrate or a printed circuit board, but the present disclosure does not limit the material of the substrate 1. The substrate 1 can further include an electrical connector 11, such that the sensor modules 2 can be electrically connected to an electrical component (not shown in the drawings).

In the present embodiment, the quantity of the sensor modules 2 is exemplified as being three, but the present disclosure is not limited thereto. For example, in other embodiments, the quantity of the sensor modules 2 can be two or more than three. In addition, each of the sensor modules 2 can be a multi-package ball grid array (mPBGA) or a plastic leaded chip carrier (PLCC), but the present disclosure is not limited thereto.

Each of the sensor modules 2 includes a sensor chip 21, a frame body 22, and a light-permeable member 23. The sensor chip 21 is disposed on the substrate 1, the frame body 22 is disposed on the substrate 1 and surrounds the sensor chip 21, and the light-permeable member 23 is disposed on the frame body 22. Specifically, the light-permeable member 23, the frame body 22, and the substrate 1 jointly define an enclosed space SP, and the sensor chip 21 is disposed in the enclosed space SP.

The sensor chip 21 can be an image sensor chip, but the present disclosure is not limited thereto. In addition, each of the sensor modules 2 can further include a plurality of wires W. Each of the wires W has one end connected to the substrate 1, and has another end connected to the sensor chip 21.

It is worth mentioning that, a thickness of the sensor chip 21 of at least one of the sensor modules 2 is different from a thickness of the sensor chip 21 of another one of the sensor modules 2. In the present embodiment, the sensor chip 21 of each of the sensor modules 2 has a different thickness, but the present disclosure is not limited thereto.

In other words, in the integrated sensor package structure 100 of the present disclosure, different sensor modules 2 are integrated on the substrate 1, so as to achieve an effect of simplifying an overall structure. In addition, the sensor modules 2 include the sensor chips 21 having different thicknesses, so that the integrated sensor package structure 100 can be adapted to different focusing distances.

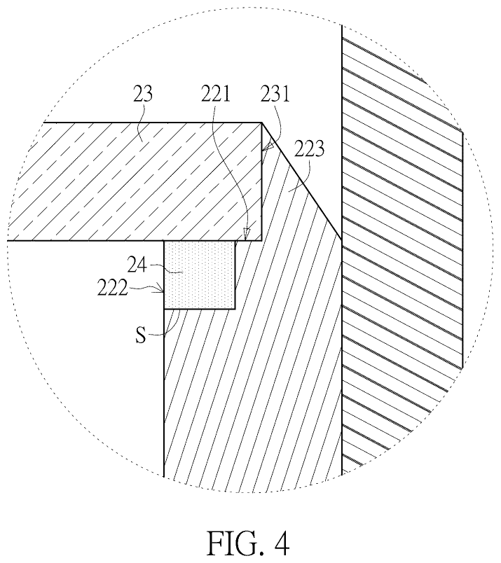

Referring to FIG. 1 to FIG. 3, which are to be read in conjunction with FIG. 4, FIG. 4 is a schematic enlarged view of part IV of FIG. 3. In each of the sensor modules 2, the frame body 22 has an annular shape, and a top end surface 221 of the frame body 22 has a notch 222, such that the top end surface 221 of the frame body 22 has a step-shaped structure S. Specifically, the notch 222 can have an annular shape, and the notch 222 can be formed at one side (e.g., an inner edge) of the top end surface 221 of the frame body 22 that is adjacent to the sensor chip 21. In addition, the frame body 22 can be, for example, a molding compound, but the present disclosure is not limited thereto.

The light-permeable member 23 can be, for example, a transparent glass, but the present disclosure is not limited thereto. The light-permeable member 23 can be disposed on the top end surface 221 of the frame body 22, and a gap (not labelled) can be formed between the light-permeable member 23 and the notch 222 of the frame body 22.

In addition, each of the sensor modules 2 can further include an adhesive layer 24, and the adhesive layer 24 is gaplessly connected in-between the notch 222 of the frame body 22 and the light-permeable member 23. The adhesive layer 24 can be arranged at the gap between the light-permeable member 23 and the notch 222 of the frame body 22, such that the light-permeable member 23 can be adhered to the frame body 22 through the adhesive layer 24. In addition, the frame body 22 of each of the sensor modules 2 can have a protruding edge portion 223, the protruding edge portion 223 has an annular shape and protrudes from the top end surface 221 of the frame body 22, and the protruding edge portion 223 surrounds an annular side surface 231 of the light-permeable member 23, but the present disclosure is not limited thereto.

Each of the optical modules 3 includes a frame 31 surrounding a corresponding one of the sensor modules 2 and at least one lens 32 mounted on the frame 31. In addition, in the present embodiment, each of the optical modules 3 is exemplified as including three lenses 32, but the present disclosure is not limited thereto. In other embodiments, the quantity of the lenses 32 included in each of the optical modules 3 can be one, two, or more than three. For example, the frame body can be made of a solder mask material, a ceramic material, or a molding compound, but the present disclosure is not limited thereto.

In each of the optical modules 3, the frame 31 includes a supporting portion 311 and a holding portion 312, the supporting portion 311 is disposed on the substrate 1 and surrounds the corresponding one of the sensor modules 2, the holding portion 312 is arranged at one end of the supporting portion 311 away from the substrate 1, and the holding portion 312 can hold the at least one lens 32. In addition, each of the optical modules 3 can further include a lens barrel 33, and the lens barrel 33 is disposed on the holding portion 312, such that the holding portion 312 can hold the at least one lens 32 through the lens barrel 33.

It is worth mentioning that, in each of the sensor modules 2, the thickness of the sensor chip 21 can be in a positive relationship with a height of the frame 31 (e.g., a distance between the substrate 1 and one end of the frame 31 away from the substrate 1) of a corresponding one of the optical modules 3, but the present disclosure is not limited thereto. In other words, the greater the thickness of the sensor chip 21 is, the greater the height of the frame 31 of the corresponding one of the optical modules 3 is. In this way, the greater the thickness of the sensor chip 21 is, the greater a distance between the at least one lens 32 mounted on the corresponding frame 31 and the sensor chip 21 is. In other embodiments, the height of the frame 31 can be also changed according to practical requirements, and the present disclosure is not limited thereto.

### Second Embodiment

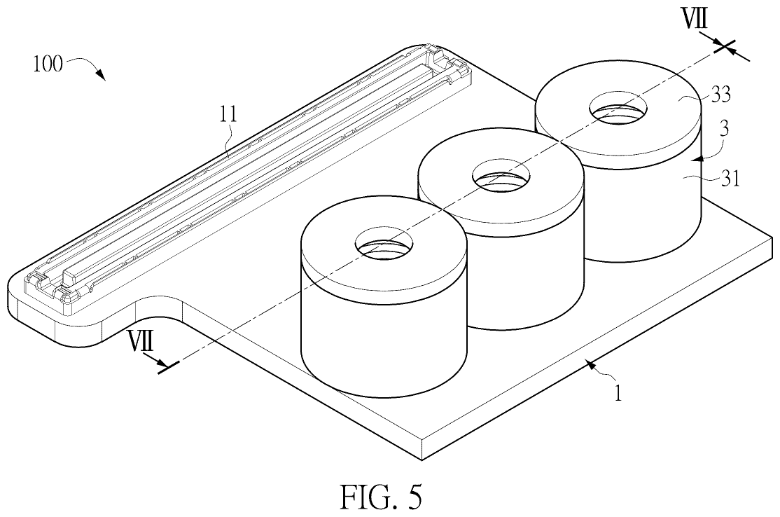

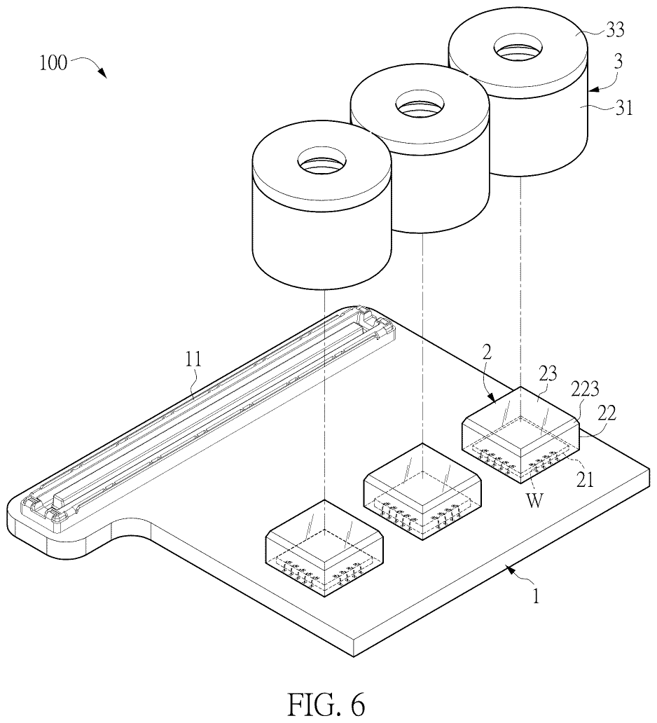

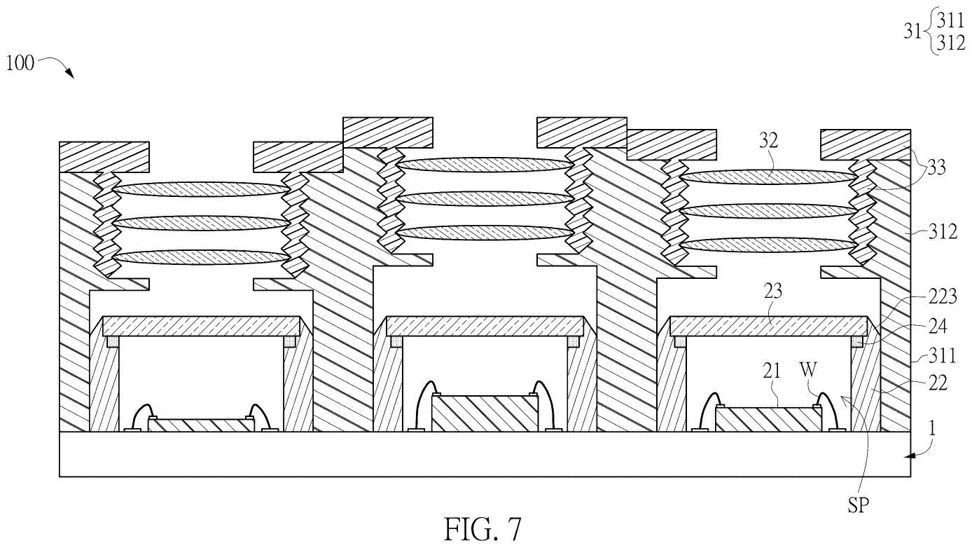

Referring to FIG. 5 to FIG. 7, FIG. 5 is a schematic perspective view of an integrated sensor package structure according to a second embodiment of the present disclosure, FIG. 6 is a schematic exploded view of the integrated sensor package structure according to the second embodiment of the present disclosure, and FIG. 7 is a schematic cross-sectional view taken along line VII-VII of FIG. 5. A second embodiment of the present disclosure is similar to the above-mentioned first embodiment, and the similarities therebetween will not be reiterated herein. The differences between these two embodiments are described as follows.

In the present embodiment, the integrated sensor package structure 100 can include only one optical module 3, the frame 31 is disposed on the substrate 1 and surrounds an outer periphery of each of the sensor modules 2, and the frame 31 can be integrally formed.

Specifically, in the optical module 3, the frame 31 include multiple ones of the supporting portion 311 and multiple ones of the holding portion 312. Each of the supporting portions 311 is disposed on the substrate 1 and surrounds a corresponding one of the sensor modules 2, each of the holding portions 312 can hold the at least one lens 32, and the supporting portions 311 and the holding portions 312 are integrally formed.

In each of the sensor modules 2, the thickness of the sensor chip 21 is in a positive relationship with a height of a corresponding one of the holding portions 312 (e.g., a distance between the substrate 1 and one end of the holding portion 312 away from the substrate 1) of the frame 31. In this way, the greater the thickness of the sensor chip 21 is, the greater a distance between the at least one lens 32 mounted on the holding portion 312 and the sensor chip 21 is.

### Third Embodiment

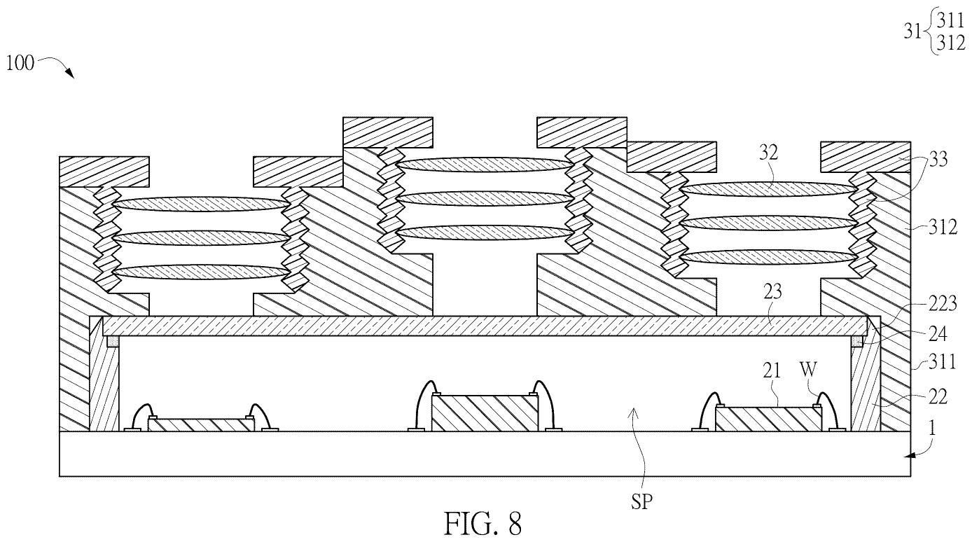

Referring to FIG. 8, FIG. 8 is a schematic view of an integrated sensor package structure according to a third embodiment of the present disclosure. A third embodiment of the present disclosure is similar to the above-mentioned second embodiment, and the similarities therebetween will not be reiterated herein. The differences between these two embodiments are described as follows.

In the present embodiment, the quantity of the supporting portion 311 included in the frame 31 is one, the quantity of the frame body 22 is one, the supporting portion 311 surrounds the sensor chips 21, the light-permeable member 23, and the frame body 22, and the frame body 22 surrounds the sensor chips 21.

In addition, in the present embodiment, the quantity of the light-permeable member 23 is one, and the light-permeable member 23 is arranged above the sensor chips 21. In other words, a projection area formed by orthographically projecting each of the sensor chips 21 toward the light-permeable member 23 is located on a bottom surface of the light-permeable member 23, and the sensor chips 21 are disposed in the enclosed space SP. In addition, each of the holding portions 312 is arranged at one side of the supporting portion 311 away from the substrate 1, and a bottom surface of each of the holding portions 312 of the frame 31 is directly disposed on the light-permeable member 23, but the present disclosure is not limited thereto.

### Beneficial Effects of the Embodiments

In conclusion, in the integrated sensor package structure provided by the present disclosure, by virtue of “the sensor chips being disposed on the substrate” and “a thickness of at least one of the sensor chips being different from a thickness of another one of the sensor chips,” the problem of insufficient structural simplicity in a conventional sensor package structure can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An integrated sensor package structure, comprising:
a substrate;
a plurality of sensor modules, wherein each of the sensor modules includes:
a sensor chip disposed on the substrate;
a frame body disposed on the substrate, wherein the frame body surrounds the sensor chip; and
a light-permeable member disposed on the frame body, wherein the light-permeable member, the frame body, and the substrate jointly define an enclosed space, and the sensor chip is disposed in the enclosed space; and
a plurality of optical modules, wherein each of the optical modules includes:
a frame surrounding a corresponding one of the sensor modules; and
at least one lens mounted on the frame;
wherein a thickness of the sensor chip of at least one of the sensor modules is different from a thickness of the sensor chip of another one of the sensor modules.

2. The integrated sensor package structure according to claim 1, wherein, in each of the sensor modules, the frame body has a notch formed on a top end surface thereof, such that the top end surface of the frame body has a step-shaped structure.

3. The integrated sensor package structure according to claim 2, wherein each of the sensor modules includes an adhesive layer, and the adhesive layer is gaplessly connected in-between the notch of the frame body and the light-permeable member.

4. The integrated sensor package structure according to claim 2, wherein the frame body of each of the sensor modules has a protruding edge portion, the protruding edge portion has an annular shape and protrudes from the top end surface of the frame body, and the protruding edge portion surrounds an annular side surface of the light-permeable member.

5. The integrated sensor package structure according to claim 1, wherein, in each of the optical modules, the frame includes a supporting portion and a holding portion, the supporting portion is disposed on the substrate and surrounds the corresponding one of the sensor modules, and the holding portion is configured to hold the at least one lens.

6. The integrated sensor package structure according to claim 1, wherein, in each of the sensor modules, the thickness of the sensor chip is in a positive relationship with a height of the frame of a corresponding one of the optical modules.

7. An integrated sensor package structure, comprising:
a substrate;
a plurality of sensor modules, wherein each of the sensor modules includes:
a sensor chip disposed on the substrate;
a frame body disposed on the substrate, wherein the frame body surrounds the sensor chip; and
a light-permeable member disposed on the frame body, wherein the light-permeable member, the frame body, and the substrate jointly define an enclosed space, and the sensor chip is disposed in the enclosed space; and
an optical module, wherein the optical module includes:
a frame disposed on the substrate, wherein the frame surrounds an outer periphery of each of the sensor modules, and the frame is integrally formed; and
at least one lens mounted on the frame;
wherein a thickness of the sensor chip of at least one of the sensor modules is different from a thickness of the sensor chip of another one of the sensor modules.

8. The integrated sensor package structure according to claim 7, wherein, in each of the sensor modules, the frame body has a notch formed on a top end surface thereof, such that the top end surface of the frame body has a step-shaped structure.

9. The integrated sensor package structure according to claim 8, wherein each of the sensor modules includes an adhesive layer, and the adhesive layer is gaplessly connected in-between the notch of the frame body and the light-permeable member.

10. The integrated sensor package structure according to claim 8, wherein the frame body of each of the sensor modules has a protruding edge portion, the protruding edge portion has an annular shape and protrudes from the top end surface of the frame body, and the protruding edge portion surrounds an annular side surface of the light-permeable member.

11. The integrated sensor package structure according to claim 7, wherein, in the optical module, the frame includes a plurality of supporting portions and a plurality of holding portions, each of the supporting portions is disposed on the substrate and surrounds a corresponding one of the sensor modules, each of the holding portions is configured to hold the at least one lens, and the supporting portions and the holding portions are integrally formed.

12. The integrated sensor package structure according to claim 11, wherein, in each of the sensor modules, the thickness of the sensor chip is in a positive relationship with a height of a corresponding one of the holding portions of the frame.

13. An integrated sensor package structure, comprising
a substrate;
a plurality of sensor chips disposed on the substrate;
a light-permeable member arranged above the sensor chips; and
an optical module including:
a frame including:
a supporting portion disposed on the substrate, wherein the supporting portion surrounds the sensor chips and the light-permeable member; and
a plurality of holding portions, wherein the plurality of holding portions are each disposed at one side of the supporting portion away from the substrate; and
a plurality of lenses mounted on the holding portions of the frame;
wherein a thickness of at least one of the sensor chips is different from a thickness of another one of the sensor chips.

14. The integrated sensor package structure according to claim 13, further comprising a frame body, wherein the frame body is disposed on the substrate and surrounds the sensor chips, and the light-permeable member is disposed on the frame body.

15. The integrated sensor package structure according to claim 14, wherein the frame body has a notch formed on a top end surface thereof, such that the top end surface of the frame body has a step-shaped structure.

16. The integrated sensor package structure according to claim 15, further comprising an adhesive layer, wherein the adhesive layer is gaplessly connected in-between the notch of the frame body and the light-permeable member.

17. The integrated sensor package structure according to claim 15, wherein the frame body has a protruding edge portion, the protruding edge portion has an annular shape and protrudes from the top end surface of the frame body, and the protruding edge portion surrounds an annular side surface of the light-permeable member.

18. The integrated sensor package structure according to claim 13, wherein a thickness of each of the sensor chips is in a positive relationship with a height of a corresponding one of the holding portions of the frame.

19. The integrated sensor package structure according to claim 13, wherein, in the optical module, a bottom surface of each of the holding portions of the frame is directly disposed on the light-permeable member.
